(19) United States
(12) Patent Application Publication
(10) Pub. No.: US 2017/0295373 A1
(43) Pub. Date: Oct. 12, 2017

(54) ENCODING IMAGE DATA AT A HEAD MOUNTED DISPLAY DEVICE BASED ON POSE INFORMATION

(71) Applicant: Google Inc., Mountain View, CA (US)

(72) Inventor: Zhibin Zhang, Mountain View, CA (US)

(21) Appl. No.: 15/379,704

(22) Filed: Dec. 15, 2016

Related U.S. Application Data
(60) Provisional application No. 62/319,889, filed on Apr. 8, 2016.

(51) Int. Cl. H04N 19/136; H04N 19/44; G06T 7/11; H04N 19/176; G06K 9/00; G06K 9/66; G06T 3/40; G06F 3/01; G06T 19/00

(52) U.S. Cl. CPC H04N 19/136; G06F 3/012; H04N 19/44; G06T 7/11; G06F 3/013; G06T 19/006; G06K 9/0061; G06K 9/66; G06T 3/40; H04N 19/176

(57) ABSTRACT

An HMD device encodes different portions of an image for display with different encoding characteristics based on a user's predicted area of focus as indicated by one or more of a pose of the HMD device and a gaze direction of the user's eye(s) identified at the HMD device. By employing different encoding characteristics, the HMD device supports relatively high-quality encoding while maintaining a relatively small size of the encoded image to allow for transfer of the image to a display panel at a high frame rate. Thus, the HMD device can encode a portion of the image that is expected to be in the user's area of focus at a high resolution, and encode the portion of the image that is expected to be in the user's peripheral vision at a lower resolution.

### BACKGROUND

### Field of the Disclosure

The present disclosure relates generally to head mounted display (HMD) devices and more particularly to encoding image data at an HMD device.

### Description of the Related Art

Head mounted display (HMD) devices are used in a variety of virtual reality (VR) and augmented reality (AR) systems. The HMD device typically includes one or more display panels to present stereoscopic imagery to the user, thereby virtually immersing the user a three-dimensional (3D) scene. The stereoscopic imagery is generated at one or more processors based, for example, on imagery captured at one or more cameras of the HMD device. However, because of power requirements and other constraints, it can be difficult to co-locate the one or more processors with the display panels at the HMD device. Instead, the processors are typically located remotely from the display panels, such as at a smartphone or portable computing device, and communicate images to the display panels via an interconnect such as a metal or fiber optic cable. However, bandwidth limitations at the interconnect can in turn limit the resolution or frame rate of the communicated images, resulting in an unsatisfying user experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an HMD device that encodes different portions of an image using different encoding characteristics based on a user's expected area of focus in accordance with at least one embodiment of the present disclosure.

FIG. 2 is a diagram illustrating an example of encoding, at the HMD device of FIG. 1, different portions of an image at different resolutions based on a user's expected area of focus in accordance with at least one embodiment of the present disclosure.

FIG. 3 is a diagram illustrating an example of encoding, at the HMD device of FIG. 1, different portions of an image at different resolutions over time based on changes in a user's expected area of focus in accordance with at least one embodiment of the present disclosure.

FIG. 4 is a diagram illustrating an example of identifying, at the HMD device of FIG. 1, a motion vector for encoding an image based on changes in the pose of the HMD device in accordance with at least one embodiment of the present disclosure.

FIG. 5 is a flow diagram of a method of encoding different portions of an image using different encoding characteristics based on a user's expected area of focus in accordance with at least one embodiment of the present disclosure.

### DETAILED DESCRIPTION

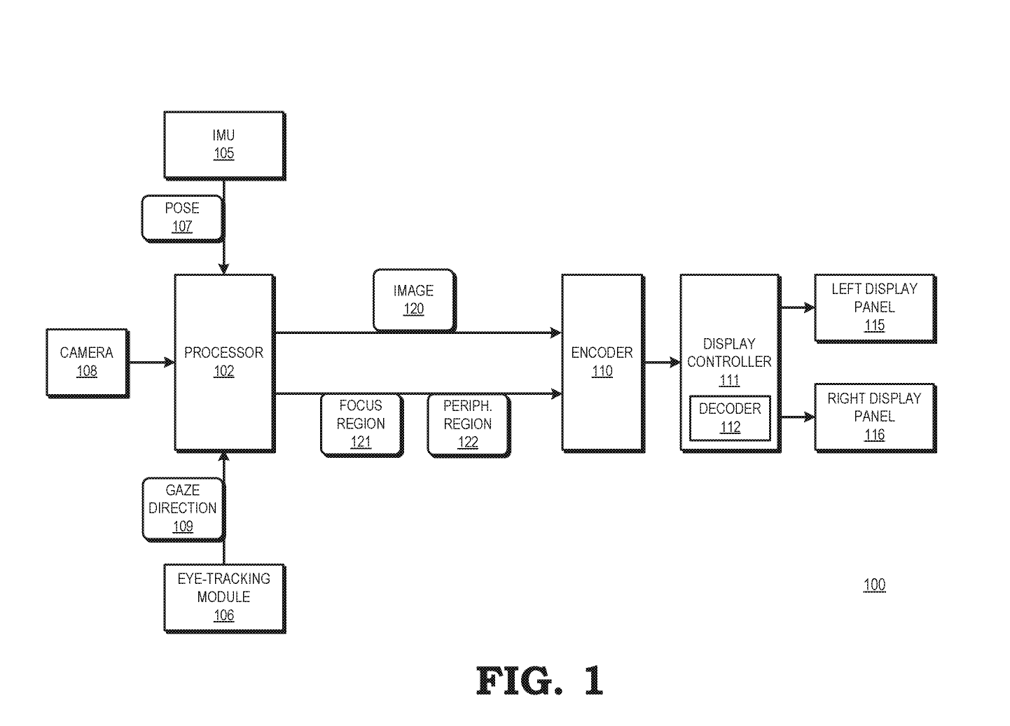

FIGS. 1-5 illustrate techniques for encoding, at an HMD device, different portions of an image for display with different encoding characteristics based on a user's predicted area of focus as indicated by one or more of a pose of the HMD device and a gaze direction of the user's eye identified at the HMD device. By employing different encoding characteristics, the HMD device supports relatively high-quality encoding while maintaining a relatively small size of the encoded image to allow for transfer of the image to a display panel at a high frame rate. For example, the HMD device can encode a portion of the image that is expected to be in the user's area of focus at a high resolution, and encode the portion of the image that is expected to be in the user's peripheral vision at a lower resolution. This allows the portion of the image that the user is focused on to be displayed at a high resolution to support a satisfying user experience, but allows the portion of the image in the user's peripheral vision to be encoded at the lower resolution to reduce the size of the overall encoded image.

As used herein, the term “encoding characteristics” refers to any video encoder parameter or setting that changes an aspect of an encoded image output by the video encoder. Examples of encoding characteristics include a resolution, bit rate, pixel block encoding size, and the like. As described further below, an HMD device is generally configured to display images to a user, whereby different portions of each image can be displayed at different resolutions. The HMD device can identify a user's expected area of focus with respect to the displayed image, and display the portion of the image in the area of focus at a relatively high resolution, while displaying the portion of the image outside the area of focus (i.e., in the user's peripheral vision) at a relatively low resolution. The encoding requirements for each portion of the image in order to achieve a satisfying user experience are therefore different. Accordingly, the HMD device encodes the different portions of the image at, for example, different resolutions, thereby reducing the size of the overall encoded image relative to conventional approaches, while still supporting display of high resolution images in the user's area of focus.

FIG. 1 illustrates a block diagram of an HMD device 100 that supports encoding different portions of an image for display using different encoding characteristics in accordance with at least one embodiment of the present disclosure. In at least one embodiment the HMD device 100 is at least partially disposed into housing or other enclosure (not shown) having a form factor that supports attachment to a user's head, such as a goggles or glasses form factor. In particular, enclosure is formed such that, when it is attached to the user's head, the form factor facilitates display of imagery to the user's eyes. In other embodiments, the HMD device 100 may be a tablet, smartphone, or other electronic device that is not physically attached to the user's head via a mechanical attachment, but instead is held by the user in a relatively fixed position with respect to the user's eyes.

The HMD device 100 is generally configured to provide virtual reality (VR) or augmented reality (AR) content to the user. For purposes of description, the term VR content is used herein to refer either or both of VR content or AR content. To support provision of the VR content, the HMD device 100 includes a processor 102, a motion sensor 105, a camera 108, an encoder 110, a display controller 111, and display panels 115 and 116. In at least one embodiment, the display panels 115 and 116 each correspond to a user's eye, in that they are disposed in the housing of the HMD device 100 such that, when worn properly, each of the display panels 115 and 116 is positioned near the corresponding eye and such that each eye of the user can easily view images at the corresponding display panel. This facilitates presentation of stereoscopic three-dimensional (3D) images to the user to enhance the VR experience. In the example of FIG. 1, the display panel 115 corresponds to the left eye of the user, and is therefore designated “left display panel”, while the display panel 116 corresponding to the right eye of the user, and is therefore designated “right display panel.”

The processor 102 is generally configured to execute sets of instructions organized as computer programs, including at least one VR application that generates images (e.g. image 120) for display at the display panels 115 and 116. In at least one embodiment, the VR application identifies movements of the HMD device 100 that correspond to movements of at least the user's head, and generates the images based on the user's movements to give the user the impression that she is moving through a virtual world. To support identification of movement, the HMD device employs the motion sensor 115. In at least one embodiment, the motion sensor 105 is an inertial measurement unit (IMU) that includes one or more gyroscopes, accelerometers, and other motion sensing devices, and thus also may be referenced herein as “IMU 105”. The IMU 105 periodically generates, based on electrical signals generated by the motion sensing devices in response to movement, information (e.g. pose 107) indicative of a pose of the user's head. The pose can be employed by the VR application to identify a corresponding pose of the user in the virtual world, and to generate images reflecting that corresponding pose.

The pose information generated by the IMU 105 can be augmented by images generated by the camera 108 and the eye-tracking module 106. To illustrate, in at least one embodiment the camera 108 is a digital camera device mounted on a housing of the HMD device 100 and configured to periodically capture images of the environment around the HMD device 100. The processor 102 can analyze the captured images to identify prominent features of the environment, and compare the identified features to a stored database (not shown) of known features and their corresponding positions in a frame of reference. Based on these positions, the processor 102 can refine the pose information generated by the IMU 105.

The eye-tracking module 106 is generally configured to generate information (e.g., gaze direction 109) indicating a direction of the user's gaze. In at least one embodiment, the eye-tracking module 106 includes one or more cameras arranged to periodically capture images of the user's eyes and includes a processing module configured to analyze the captured images to identify the gaze direction. For example, based on the captured images the processing module of the eye-tracking module 106 can use edge detection techniques to identify an outline of the user's eye and an outline of the user's iris, and identify the gaze direction 109 based on the positional relationship between the outline of the user's eye and the outline of the iris. In at least one embodiment, the processor 102 can refine the pose information generated by the IMU 105 based on the gaze direction 109.

In at least one embodiment, for each image generated by the VR application the processor 102 identifies two regions based on the most recent identified pose and the most recent gaze direction: a focus region (e.g. focus region 121) and a peripheral region (e.g. peripheral region 122). The focus region corresponds to the expected area of focus in the image for the user, while the peripheral region corresponds to the area outside of the focus region—that is, the region of the image that is expected to be in the user's peripheral vision. In at least one embodiment, the processor 102 identifies the focus region by identifying, based on the pose information a vector indicating a direction of movement of the user's head. Based on that vector, the processor 102 determines a portion of the image, such as the left portion, right portion, upper portion, or lower portion. The processor 102 then uses the gaze direction to refine the identified portion to derive the focus region. For example, the processor 102 can identify a vector with an origin at the center of the user's iris and a direction matching the gaze direction, and identifying where the vector intersects with the previously identified portion of the image. The processor 102 then defines the focus region as a circular, oval, rectangular, or other shaped region with a center point at the identified intersection. The processor 102 further defines the peripheral region as the portion of the image not included within the focus region.

The encoder 110 is generally configured to encode images received from the processor 102 for transmission to the display controller 111. In at least one embodiment, the processor 102 provides the encoder with an image (e.g. image 120) for display and information indicating the focus region (e.g. focus region 121) and peripheral region (e.g. peripheral region 122) for the image. The encoder 110 separates the image into the corresponding region, and encodes each region using different encoding parameters. The encoding parameters used for each region may be pre-defined and stored at the encoder 110 or may be supplied by the processor 102 with the focus region and peripheral region information. In at least one embodiment, the encoding characteristics for the focus region and for the peripheral region are such that the encoded image for the focus region has a higher resolution than the encoded image for the peripheral region. The encoding characteristics for the focus region may therefore differ from the encoding characteristics for the peripheral region for one or more of a variety of encoding variables. For example, the encoding characteristics for the focus region may employ a higher bit rate than the encoding characteristics for the peripheral region. In another embodiment, the encoding characteristics for the focus region may employ a smaller pixel block encoding size than the encoding characteristics for the peripheral region, such as a smaller macroblock encoding size.

The display controller 111 includes a decoder 112 to decode the received images. In at least one embodiment, the decoder 112 decodes the images corresponding to the different regions, then stitches the decoded images together to generate a decoded image for display. The decoded image will include a higher resolution portion, corresponding to the focus region, and a lower resolution portion, corresponding to the peripheral region. The display controller 111 then renders the decoded image to one or more of the display panels, so that the focus region is displayed within the user's area of focus at the higher resolution, while the peripheral region of the image is displayed in the user's peripheral vision at the lower resolution. The HMD device 100 thus maintains a high level of quality for the portion of the image that is in the user's area of focus, while reducing the amount of data transferred between the encoder 110 and the display controller 111. This in turn can enable the HMD device 100 to employ higher-quality images, display images to the user at a higher frame rate, and the like.

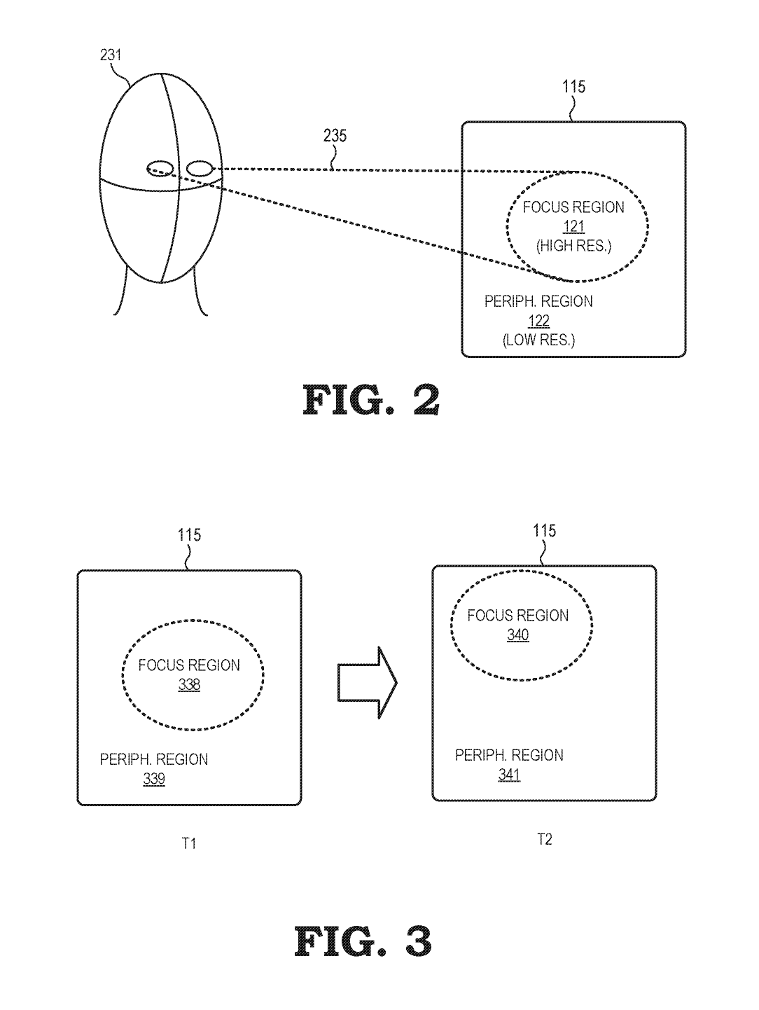

FIG. 2 is a block diagram illustrating different regions of the display panel 115 in accordance with at least one embodiment of the present disclosure. In the illustrated example of FIG. 2, a user 231 looks at the display panel 115. Based on the pose of the head of the user 231, as well as a gaze direction 235 as identified by the eye-tracking module 106, the processor 102 identifies the focus region 121. In addition, the processor 102 identifies the peripheral region 122 as the region of the image to be displayed that is not included in the focus region 121. The processor 102 provides information to the encoder 110 indicating the focus region 121 and the peripheral region 122. In response, the encoder 110 divides the image 120 into two sub-images, with one sub-image (designated the focus sub-image) corresponding to the focus region 121 and one sub-image (designated the peripheral sub-image) corresponding to the peripheral region 122. The encoder 110 encodes the focus sub-image based on high-resolution encoding characteristics, such that the focus sub-image is encoded at a relatively high resolution. In addition, the encoder 110 encodes the peripheral sub-image based on low-resolution encoding characteristics, such that he peripheral sub-image is encoded at a relatively low resolution.

The encoder 110 provides the focus sub-image and the peripheral sub-image to the display controller 111, which uses the decoder 112 to decode each sub-image. The display controller 111 then stitches the decoded sub-images together, resulting in a representation of the image 120 having a high-resolution portion corresponding to the focus region 121 and a low-resolution portion corresponding to the peripheral region 122. The display controller 111 displays the stitched image at the display panel 115, thereby display high-resolution imagery in the area of focus of the user 231 and low-resolution imagery in the peripheral vision of the user 231. The user 231 thereby experiences a satisfying visual experience while the HMD device 100 is able to reduce the overall amount of encoded image information communicated between the encoder 110 and the display controller 111.

In addition, as the user's pose and gaze direction change over time, the HMD device 100 commensurately alters the focus region and peripheral region so that the high-resolution portion of the displayed image remains within the user's area of focus. An example is illustrated at FIG. 3 in accordance with at least one embodiment of the present disclosure. In the depicted example, at a time designated T1 the display panel 115 displays an image having a focus region 338 having a center at or near the center of the image, and a peripheral region 339 surrounding the focus region 338. The focus region 338 and peripheral region 339 are identified by the HMD device 100 based on the pose of the user and the user's eye position at or just before time T1.

Subsequently, at or just before a time designated T2, the HMD device 100 identifies a different pose and eye position of the user and in response updates the focus region and the peripheral region. In particular, the HMD device 100 identifies a focus region 340 at or near the top of the image and a peripheral region 341 surrounding the focus region 340. Accordingly, the HMD device 100 adjusts the portions of the image that are encoded and displayed at a high resolution to correspond to the focus region 340 and adjusts the portions of the image that are encoded and displayed at a low resolution to correspond to the peripheral region 341.

As illustrated at FIG. 3, the focus region 340 overlaps with the peripheral region 339. That is, as the area of focus of the user changes, the portion of the image displayed at high resolution also changes, such that a portion of the display panel 115 displayed at a high resolution at time T1 is displayed at a low resolution at time T2. The HMD device 100 thereby maintains high resolution imagery in the user's area of focus while reducing the encoding overhead for the portions of the image that are in the user's peripheral vision.

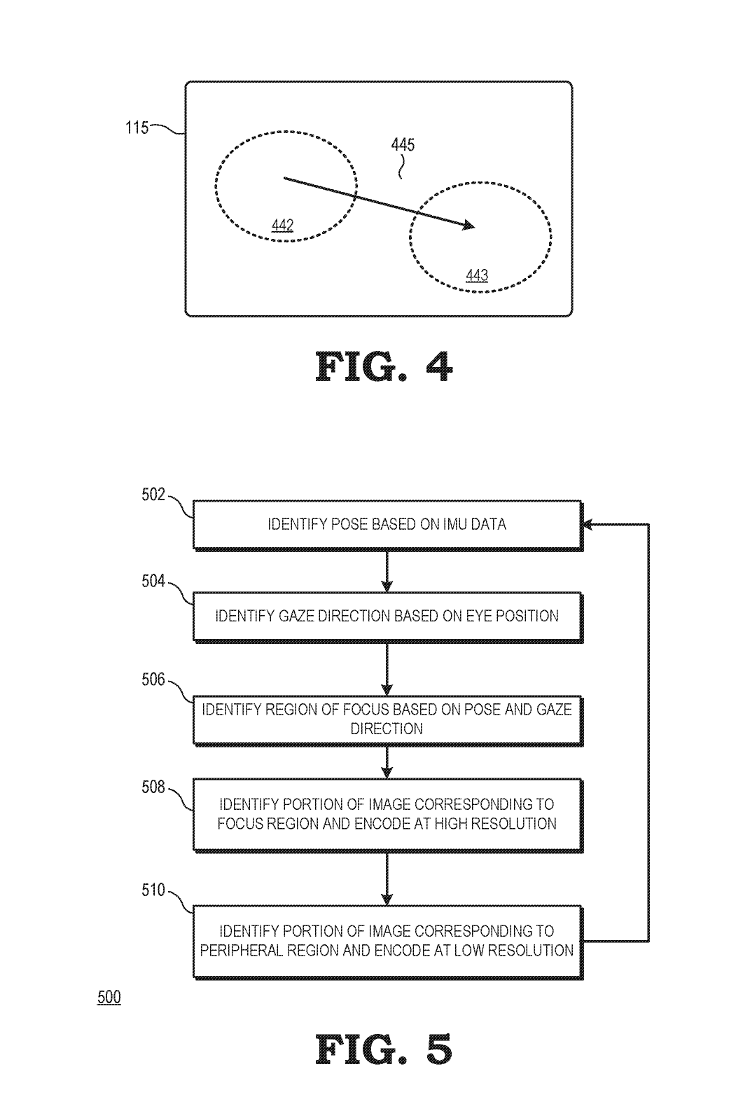

In some embodiments, the HMD device 100 can improve the image encoding process by using information about changes in the user's pose to identify motion vectors for encoding. An example is illustrated at FIG. 4 in accordance with at least one embodiment of the present disclosure. FIG. 4 depicts focus regions 442 and 443, each corresponding to a different time, with the focus region 443 corresponding to a time after the time corresponding to focus region 442. The difference between the focus regions 442 and 443 represents a change in the pose of the user's head. Accordingly, in at least one embodiment the HMD device 100 identifies the difference in the focus regions 442 and 443 by selecting a point within the focus region 442 and a corresponding point of the focus region 443. Then HMD device 100 then identifies the difference between the two points to identify a vector 445 representative of the motion of the user's head as it changes between poses. The encoder 110 can use the vector 445, or a representation thereof, as a motion vector for encoding the image corresponding to focus region 443 according to a conventional image encoding process.

In at least one embodiment, the HMD device 100 identifies the vector 445 based on an average of the difference between multiple corresponding points of the focus regions 442 and focus region 443. In still another embodiment, the HMD device 100 identifies the vector 445 based on differences in pose information generated by the IMU 105 over time, rather than from differences in the focus region.

FIG. 5 is a flow diagram of a method 500 of encoding different portions of an image using different encoding characteristics based on a user's expected area of focus in accordance with at least one embodiment of the present disclosure. The method 500 is described with respect to an example implementation at the HMD device 100 of FIG. 1. At block 502 the processor 102 identifies the pose 107 based on information received from the IMU 105. At block 504 the processor 102 identifies the gaze direction 109 based on the position of the user's eye as indicated by the eye-tracking module 106.

At block 506 the processor 102 identifies the expected area of focus for the user based on the pose 107 and the gaze direction 109. At block 508 the processor 102 identifies the focus region 121 as the portion of the image 120 corresponding to the expected area of focus. The processor 102 provides the focus region 121 to the encoder 110, which encodes the corresponding portion of the image 120 at a relatively high resolution. In addition, at block 510 the processor 102 identifies the peripheral region 122 as the portion of the image 120 not included in the focus region 121. The processor 102 provides the peripheral region 122 to the encoder 110, which encodes the corresponding portion of the image 120 at a relatively low resolution. The overhead for encoding the image 120 is thereby reduced, including the size of the encoded information representing the image 120, the speed with which all portions of the image 120 are encoded, and the like. After, or concurrent with, the encoding of the image 120, the method flow returns to block 502. Thus, the HMD device 100 continues to monitor changes in the user's pose and gaze direction and make commensurate updates to the focus and peripheral regions of images generated by the processor 102.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying at a head mounted display (HMD) device a first pose of a user's head;
identifying a first region and a second region of a display panel of the HMD based on the identified first pose;
encoding a first portion of a first image based on first encoding characteristics in response to identifying that the first portion is to be displayed at the first region;
encoding a second portion of the first image based on second encoding characteristics in response to identifying that the second portion is to be displayed at the second region, the second encoding characteristics different from the first encoding characteristic; and
decoding the encoded first image for display at a display panel of the HMD device.

2. The method of claim 1, further comprising:
identifying at the HMD device an eye position of the user; and
wherein identifying the first region and the second region comprises identifying the first region and the second region based on the identified first pose and the identified eye position.

3. The method of claim 1, further comprising:
predicting a gaze direction of the user based on the first pose; and
wherein identifying the first region comprises identifying the first region as a region corresponding to the gaze direction of the user.

4. The method of claim 1, wherein:
the first encoding characteristics comprise a first resolution and the second encoding characteristics comprise a second resolution different from the first.

5. The method of claim 1, wherein:
the first encoding characteristics comprise a first pixel block encoding size and the second encoding characteristics comprise a second pixel block encoding size different from the first.

6. The method of claim 1, wherein:
the first encoding characteristics comprise a first bit rate and the second encoding characteristics comprise a second bit rate different from the first.

7. The method of claim 1, further comprising:
identifying at the HMD a second pose of a user's head, the second pose after the first pose;
identifying a third region and a fourth region of the display panel of the HMD based on the identified second pose;
encoding a third portion of a second image based on the first encoding characteristics in response to identifying that the third portion is to be displayed at the third region; and
encoding a fourth portion of the second image based on the second encoding characteristics in response to identifying that the fourth portion is to be displayed at the fourth region.

8. The method of claim 7, wherein the fourth region overlaps with at least a portion of the first region.

9. The method of claim 7, wherein encoding the third portion comprises:
identifying a motion vector based on a difference between the first pose and the second pose; and
encoding the third portion based on the identified motion vector.

10. A method, comprising
identifying at a head mounted display (HMD) a gaze direction of a user's eye;
identifying a first region and a second region of a display panel of the HMD based on the identified gaze direction;
encoding a first portion of a first image based on first encoding characteristics in response to identifying that the first portion is to be displayed at the first region; and
encoding a second portion of the first image based on second encoding characteristics in response to identifying that the second portion is to be displayed at the second region, the second encoding characteristics different from the first.

11. The method of claim 10, wherein the first region corresponds to a predicted area of focus for the user and the second region corresponds to a predicted area of peripheral vision for the user.

12. The method of claim 11, wherein the first encoding characteristics correspond to a first resolution and the second encoding characteristics correspond to a second resolution, the second resolution lower than the first.

13. A head mounted display (HMD) device, comprising:
a display panel;
a motion sensor to indicate a first pose of the HMD device;
a processor to identify a first region and a second region of the display panel based on the identified first pose;
an encoder to:
encode a first portion of a first image based on first encoding characteristics in response to the processor identifying that the first portion is to be displayed at the first region; and
encode a second portion of the first image based on second encoding characteristics in response to the processor identifying that the second portion is to be displayed at the second region, the second encoding characteristics different from the first.

14. The HMD device of claim 13, further comprising:
an eye-tracking module to identify an eye position of a user; and
wherein the processor is to identify the first region and the second region based on the identified first post and the identified eye position.

15. The HMD device of claim 13, wherein the processor is to:
predict a gaze direction of a user based on the first pose; and
identifying the first region as a region corresponding to the gaze direction of the user.

16. The HMD device of claim 13, wherein:
the first encoding characteristics comprise a first resolution and the second encoding characteristics comprise a second resolution different from the first.

17. The HMD device of claim 13, wherein:
the first encoding characteristics comprise a first pixel block encoding size and the second encoding characteristics comprise a second pixel block encoding size different from the first.

18. The HMD device of claim 13, wherein:
the motion sensor is to identify a second pose of the HMD device;
the processor is to identify a third region and a fourth region of the display panel based on the identified second pose;
the encoder is to:
encode a third portion of a second image based on the first encoding characteristics in response to the processor indicating that the third portion is to be displayed at the third region; and
encode a fourth portion of the second image based on the second encoding characteristics in response to the processor indicating that the fourth portion is to be displayed at the fourth region.

19. The HMD device of claim 18, wherein the fourth region overlaps with at least a portion of the first region.

20. The HMD device of claim 18, wherein:
the processor is to identifying a motion vector based on a difference between the first pose and the second pose; and
the encoder is to encode the third portion based on the identified motion vector.
